(19) United States
(12) Patent Application Publication
(10) Pub. No.: US 2026/0209975 A1
(43) Pub. Date: Jul. 23, 2026

(54) SYSTEM AND METHOD FOR HYDROGEN STORAGE AND RELEASE

(71) Applicant: Ayrton Energy Inc., Calgary (CA)

(72) Inventors: Brandy PILAPIL, Calgary (CA); Natasha KOSTENUK, Calgary (CA)

(21) Appl. No.: 19/137,190

(22) PCT Filed: Dec. 11, 2023
(86) PCT No.: PCT/CA2023/051638

§ 371 Date: Jun. 9, 2025

Related U.S. Application Data
(60) Provisional application No. 63/431,583, filed on Dec. 9, 2022.

(51) Int. Cl. C25B 15/08; C25B 1/02; C25B 3/23; C25B 9/17; F17C 5/00

(52) U.S. Cl. CPC C25B 15/08; C25B 1/02; C25B 3/23; C25B 9/17; F17C 5/00; F17C 2221/012; F17C 2265/06

(57) ABSTRACT

The present invention provides a system and method for managing hydrogen storage and release, utilizing hydrogen carrier fluid (HCF) and undivided electrochemical reactors (i.e. not containing ion exchange membranes) to achieve hydrogenation/dehydrogenation of HCF.

### FIELD

The present disclosure relates to systems and methods for storage and release of hydrogen, and hydrogen transportation. More specifically, the invention is directed to system and method for a hydrogen storage and release utilizing electrocatalytic reactors and liquid organic hydrogen carriers.

### BACKGROUND

Hydrogen is one net-zero fuel being adopted widely as replacement of traditional fossil fuels due to its production pathways often being from renewable resources, clean nature, high energy density and its nature of being a sustainable transportable energy source. Hydrogen can be used in many applications to generate electricity, via pairing with fuel cells, or heat via burning, without emission of greenhouse gases.

Hydrogen transportation and distribution can be difficult due to safety concerns relating to the chemical and physical properties of hydrogen. Hydrogen can embrittle materials, as well as can easily escape from containment. It has a wide flammability range, and requires a minimal amount of energy to ignite. These concerns create barriers for the safe use of hydrogen. Solutions for hydrogen transportation include high pressure/compressed hydrogen, liquid cryogenic, or adsorption materials such as metal hydrides, each one of them have limitations, such as the ability to transport large volumes and/or long distances.

Pressurized or compressed hydrogen is transported in bulk storage vehicles, such as tube trailers, and are often limited in the volume they can transport and result in hydrogen losses, making long distance transportation less efficient. Compressed hydrogen storage and transportation can use up to 20% of its energy content. Cryogenic liquid storage is a common storage and transportation method for hydrogen, especially when high-volume transport is needed in the absence of pipelines. To liquefy hydrogen, it must be cooled to less than 20K through a liquefaction process and is then transported through liquid tankers with onboard cooling. This process can use 40% of its energy content, making it less energy efficient, and still has limitations to the volume transported in bulk containers or tankers.

Metal hydrides (formed by chemical reaction between metal(s) and hydrogen gas) are the most compact way to store hydrogen as they are denser than liquid hydrogen, and can therefore be stored at standard temperature and pressure. The hydrogen capacity of metal hydrides varies, but is low, often 1-5% by weight. Moreover, there is little ability to use metal hydrides for flow-based transport methods, such as pipelines. Furthermore the energy demand and slow kinetics of hydrogen storage/release further limit these materials for stationary applications.

Pipelines are good for transportation of hydrogen in large volumes for large distances, but a limited number of pipelines exist that have the metallurgy required to prevent pipe corrosion and integrity issues that can lead to leaks. In addition, hydrogen gas easily loses pressure along the pipeline and must be recompressed regularly (as often as every 100 km), lowering the overall efficiency of hydrogen gas pipelines.

Systems involving liquid organic hydrogen carriers (LOHC) present an opportunity for the transport of hydrogen over long distances, while mitigating hydrogen loss and pipeline corrosion. However, the energy required for the storage and release of hydrogen in an LOHC can be prohibitive to large scale deployment. This energy is typically applied as heat and pressure in batch reactors, further complicating deployment.

Liquid organic hydrogen carrier (LOHC) or hydrogen carrier fluids (HCF) refer to a chemical compound that can absorb and release hydrogen through chemical reactions. Such compounds include unsaturated hydrocarbons which undergo hydrogenation at the H₂-source site to provide a storable and transportable fluid in the form of corresponding (more) saturated hydrocarbons, which can be dehydrogenated to release hydrogen and to form hydrogen depleted fluid which is transferred to a hydrogen source site where it is converted to its saturated form by hydrogenation processes. Typical carrier fluids are the “molecule pairs” in their hydrogenated and dehydrogenated forms, for example, cyclohexane/benzene, decalin/naphthalene, etc.

Use of electrochemical conversion of LOHCs to generate electrical energy has been investigated, while by-passing the use of a direct hydrogen gas feed. These methods are limited by the development of fuel cell technology that processes the carrier fluids as an oxidant for the fuel cell stacks, such as direct methanol or solid oxide fuel cell technology.

The electrochemical reactors involving LOHC hydrogenation have been demonstration using a divided electrochemical reactor, composed of an anode and cathode provided on either side of a proton exchange membrane assembly (membrane electrode assembly, MEA). In proton exchange membrane divided reactors, leakage of organic reactants and products across the membrane can inhibit high current densities and limits the operating temperature of the reactor. These types of reactors further present a challenge owing to the instability of these membranes in contact with LOHCs.

Therefore there is a need for improved hydrogen storage and release systems that can overcome one or more of the limitations of the existing technologies.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

Herein described is a hydrogen storage and release system and method involving use of undivided electrochemical reactors for hydrogenation/dehydrogenation of liquid organic hydrogen carriers.

In accordance with an aspect of the present invention, there is provided a system for managing hydrogen storage and release, the system comprising an undivided electrochemical hydrogenation reactor (H-reactor) configured to receive a hydrogen lean carrier fluid (lean-HCF) and hydrogen gas, and a transfer system for transferring the rich-HCF from the H-reactor to a site of use, wherein the H-reactor comprising an anode for electrochemically oxidizing the hydrogen to generate protons and electrons, and a cathode for hydrogenating the lean-HCF with the generated protons and electrons to form a hydrogen rich carrier fluid (rich-HCF).

In accordance with another aspect of the present invention, there is provided a system for managing hydrogen production and storage, the system comprising an undivided electrochemical dehydrogenation reactor (D-reactor) configured to receive a hydrogen rich carrier fluid (rich-HCF), and a transfer system for transferring the lean-HCF from the D-reactor to a site of use, wherein the reactor comprising an anode for electrochemically dehydrogenating/oxidizing the rich-HCF to produce a hydrogen lean carrier fluid (lean-HCF), protons and electrons, and an cathode to generate hydrogen gas from the generated protons and electrons.

### BRIEF DESCRIPTION OF THE DRAWINGS

Further features and advantages of the present disclosure will become apparent from the following detailed description, taken in combination with the appended drawings, in which:

FIG. 1 is a schematic illustration of the hydrogen storage and release system in accordance with an embodiment of the present invention.

FIG. 2 is a schematic illustration of the hydrogen storage and release system in accordance with an embodiment of the present invention.

FIG. 3 is a schematic illustration of the hydrogen storage and release system, in accordance with an embodiment of the present invention.

FIG. 4A is a schematic illustration of a perpendicular flow electrochemical reactor, comprising a three dimensional bipolar electrode(s) assembly, in accordance with an embodiment of the present invention.

FIG. 4B is a schematic illustration of a perpendicular flow electrochemical reactor, comprising monopolar electrode(s), in accordance with an embodiment of the present invention.

FIG. 5A is a schematic illustration of a parallel flow electrochemical reactor, comprising monopolar electrode(s), in accordance with an embodiment of the present invention.

FIG. 5B is a schematic illustration of a parallel flow electrochemical reactor, porous bipolar electrode(s), in accordance with an embodiment of the present invention.

FIG. 6 is a schematic illustration of a bipolar electrode assembly for use in a system, in accordance with an embodiment of the present invention.

FIG. 7 is a schematic illustration of hydrogen carrier fluid transport enabling long-distance transport of hydrogen.

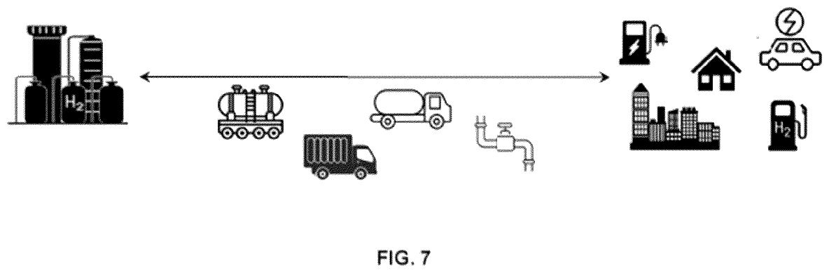

The specific arrangements shown in the Figures should not be viewed as limiting. It should be understood that the illustrated elements, including and the shape, size and scale, are not drawn in actual proportion to each other.

### DETAILED DESCRIPTION

Unless defined otherwise, all technical and scientific terms used herein have the same meaning as commonly understood by one of ordinary skill in the art to which this invention belongs.

Unless the context requires otherwise, throughout this specification and claims, the words “comprise”, “comprising” and the like are to be construed in an open, inclusive sense.

The articles “a” and “an” are used herein to refer to one or to more than one (i.e., to at least one) of the grammatical object of the article. By way of example, “an element” means one element or more than one element.

As used herein, the term “about” refers to approximately a +/−10% variation from a given value. It is to be understood that such a variation is always included in any given value provided herein, whether or not it is specifically referred to.

The terms liquid organic hydrogen carrier (LOHC) and hydrogen carrier fluid (HCF) are used interchangeably herein, and refer to organic compounds or formulations comprising organic compound that can absorb and release hydrogen through chemical reactions.

The present invention provides a system and method for managing hydrogen storage and release, utilizing hydrogen carrier fluid (HCF) and undivided electrochemical reactors (i.e. not containing ion exchange membranes) to achieve hydrogenation/dehydrogenation of HCF.

The system of the present disclosure allows for operation at temperatures that can range between the melting and boiling point of the hydrogen carrier fluid, without concern regarding membrane instabilities.

In one aspect, the system of the present disclosure comprises an undivided electrochemical hydrogenation reactor (H-reactor) configured to receive a hydrogen lean carrier fluid (lean-HCF) and hydrogen gas from a source thereof. The H-reactor comprises an anode for electrochemically oxidizing the hydrogen to generate protons and electrons, and a cathode for hydrogenating the lean-HCF with the generated protons and electrons to form a hydrogen rich carrier fluid (rich-HCF). The system further comprises a transfer system for transferring the rich-HCF from the H-reactor to a site of use.

In some embodiments, the system for hydrogenation may employ water as a source of hydrogen, without the need for hydrogen gas, wherein direct water electrolysis is used to generate hydrogen in situ. In some embodiments, hydrogen gas is mixed with water.

In some embodiments, the site of use is an undivided electrochemical dehydrogenation reactor (D-reactor) configured to receive the transferred rich-HCF. The D-reactor comprises an anode for electrochemically dehydrogenating/oxidizing the rich-HCF to generate the lean-HCF and protons and electrons, and a cathode to generate a hydrogen gas from the generated protons and electrons. The hydrogen gas is transferred for end use, for example in a hydrogen appliance (such as boiler, furnace, etc.) or fuel cell system or like, to generate heat or electrical energy for further application.

In some embodiments, the system further comprises a transfer system for recycling the lean-HCF from the D-reactor to the H-reactor.

In one aspect, the system of the present disclosure comprises an undivided electrochemical dehydrogenation reactor (D-reactor) configured to receive a hydrogen rich carrier fluid (rich-HCF). The reactor comprises an anode for electrochemically dehydrogenating/oxidizing the rich-HCF to produce a hydrogen lean carrier fluid (lean-HCF), protons and electrons, and a cathode to generate hydrogen gas from the generated protons and electrons. The system further comprises a transfer system for transferring the lean-HCF from the D-reactor to a site of use.

In some embodiments, the site of use is an undivided electrochemical hydrogenation reactor (H-reactor) configured to receive the transferred lean-HCF and hydrogen from a hydrogen source. The H-reactor comprises an anode for electrochemically oxidizing the hydrogen to generate protons and electrons, and a cathode for hydrogenating the lean-HCF with the generated protons and electrons to form a hydrogen rich carrier fluid (rich-HCF). In some embodiments, the system further comprises a transfer system for recycling the rich-HCF from the H-reactor to the D-reactor.

The undivided electrochemical H-reactors and D-rectors of the present disclosure utilize porous electrodes that can be configured for flow-through (perpendicular flow) or flow-across (parallel flow) of the electrocatalytic hydrogen carrier fluid.

The electrodes of the undivided electrochemical reactors of the present disclosure can be monopolar and/or bipolar. The electrodes can be arranged in 2D and/or 3D electrode assemblies.

In some embodiments, the H-reactors and D-rectors comprise bipolar electrode(s).

The LOHCs/HCFs suitable for use in the system of the present disclosure include cyclic hydrocarbons, optionally having one or more heteroatoms. Non limiting examples of cyclic hydrocarbons include benzene, toluene, naphthalene, decalin, dibenzyltoluene, biphenyl, n-alkyl carbazole, etc., and/or their partially or fully hydrogenated forms. These LOHCs may be used in a pure form, as a blend, or diluted with other compounds in a solution.

In some embodiments, the LOHC is toluene and/or methycylohexane.

In some embodiments, the system of the present disclosure involves use of an aqueous medium to facilitate the electrochemical reactions.

The aqueous medium can be water optionally comprising salts (such as NaCl, tetrabutylammonium hydroxide, tetrabutylammonium chloride etc.), acids (such as HCl), bases (such as NaOH) and/or emulsifiers (such as surfactants and/or amphiphilic nanoparticles).

Surfactants can be anionic, cationic and/or zwitterionic. In some embodiments, the surfactant is cocamidopropyl betaine, and/or sodium dodecyl benzene sulfonate

Non limiting examples of amphiphilic nanoparticles include trimethylsilyl modified silica or alumina nanoparticles. Amphiphilic nanoparticles may be metal oxide nanoparticles surface modified with alkyl groups (C1-C12), such that the surface has both hydroxide groups and alkyl groups.

In some embodiments, the hydrogen carrier fluid(s) may form an emulsion with the aqueous medium. The emulsion may be HCF in water or water in HCF.

In some embodiments, the HCF and the aqueous medium form a multiphase system.

In some embodiments, the porous electrodes of the H-reactors and D-reactors of the present disclosure can be made of suitable material such as carbon and/or steel, coated with a catalytic material.

In some embodiments, the electrodes of the H-reactors and D-reactors of the present disclosure can be made of a catalytic material itself.

The anode of the H-reactor comprises a catalytic material for electrochemical oxidation of hydrogen, and the cathode comprises a catalytic material for electrochemical hydrogenation/reduction of the lean-HCF.

The anode of the D-reactor comprises a catalytic material for electrochemical dehydrogenation/oxidation of the rich-HCF, and the cathode comprises comprises a catalytic material for reaction of the protons and electrons to generate hydrogen gas.

The catalytic materials for the cathode and anode can include transition metals or transition metal oxides. In some embodiments, the catalytic material are transition metal base nanoparticle electrodeposited or foam-coated on the electrode surface.

Electrochemical reactions occur at the anode (oxidation) and cathode (reduction). In the hydrogenation reactor (H-Reactor) system, hydrogen is oxidized and subsequently utilized in the reduction of the lean-HCF, adding hydrogen to produce a rich-HCF. In the dehydrogenation reactor (D-reactor) system, the rich-HCF is oxidized, producing H+ ions (protons) and/or adsorbed H, which is subsequently reduced to form hydrogen gas (H₂).

### H-Reactor Reactions:

$$Hydrogen oxidation reaction {H}_{2} -- > 2 {H}^{+} + 2 {e}^{-}$$

$$Lean - HCF reduction reaction {XH}^{+} + {Xe}^{-} + lean - HCF -- > rich - HCF$$

### D-Reactor Reactions:

$$Rich - HCF oxidation reaction Rich - HCF -- > Lean - HCF + {XH}^{+} + {Xe}^{-}$$

$$Hydrogen evolution reaction ( reduction ) 2 {H}^{+} + 2 {e}^{-} -- > {H}_{2}$$

The Gibbs free energy is estimated by the thermodynamically available energy of the electrochemical reactor at open-circuit potential based upon the following equation:

$$Δ {G}_{cell} = - {zFE}_{cell}$$

where F the Faraday constant, z is the electron stoichiometry and Ecell is the equilibrium cell potential difference. The use of catalysts at the anode and cathode accelerates the reaction by decreasing the Gibbs energy of activation without being consumed by the reaction. Electrocatalytic materials may be deposited at the anode and cathode of the electrochemical reactors accelerating the oxidation and reduction reactions, respectively. The electrochemical reactors are built upon a simple parallel plate geometry that is enhanced by the inclusion of 2 dimensional or 3 dimensional structured electrodes with optimized current distributions and mass transport rates.

In the undivided reactors of the present disclosure, high current densities can be easily achieved via formation of emulsion with water and/or via addition of the aqueous medium described herein, to the LOHC to increase the solution conductivity. Tuning of electrochemical reaction rate can be further carried out via modification of the electrode's catalyst material/morphology.

The lean-HCF from the D-reactor may be re-hydrogenated at a facility or hydrogen re-fueling hub. The rich-HCF may be used on-site for the generation of hydrogen fuel (hydrogen gas) for end application in electrical power generation, heating, or other hydrogen gas end-use cases.

The transfer system of the present management system can comprise one or more of storage containers and pipelines.

The storage containers can be compact tanks, tank trucks, or other similar storage containers. In some embodiments, the transport system comprises one or more pipelines.

In some embodiments, the H-Reactor and D-Reactor are installed at the ends of a single pipeline, parallel pipelines or concentric pipelines for recycling the lean-HCF to the H-reactor location.

The hydrogen gas generated at the D-reactor may be utilized in conjunction with hydrogen fuel cell, generator or appliance technologies to produce electrical energy, heating or refrigeration for residential or commercial applications.

In another aspect, the present invention provides a method for hydrogen storage and release. The method comprises feeding a hydrogen lean carrier fluid (lean-HCF) and hydrogen gas to an undivided electrochemical hydrogenation reactor (H-reactor) comprising an anode and a cathode. The method further includes electrochemically oxidizing the hydrogen at anode to generate protons and electrons, and hydrogenating the lean-HCF at cathode with the generated protons and electrons to form a hydrogen rich carrier fluid (rich-HCF), and transferring the generated rich-HCF to a site of use.

In another aspect, the method of hydrogen storage and release comprises feeding a hydrogen lean carrier fluid (lean-HCF) to an undivided electrochemical dehydrogenation reactor (D-reactor) comprising an anode and a cathode. The method further includes electrochemically dehydrogenating/oxidizing the rich-HCF at anode to produce a hydrogen lean carrier fluid (lean-HCF), protons and electrons, and generating hydrogen gas from the generated protons and electrons at the cathode, and transferring the lean-HCF from the D-reactor to a site of use.

In some embodiments, the rich-HCF and/or lean-HCF can be transferred via compact tanks, tank trucks, or other similar storage containers.

In some embodiments, the rich-HCF and/or lean-HCF can be transferred via one or more pipelines.

In some embodiments, the method comprises recycling the lean-HCF to the initial H-reactor by installing the H-Reactor and the D-Reactor at the ends of a single pipeline, parallel pipelines or concentric pipelines.

To gain a better understanding of the invention described herein, the following examples are set forth with reference to the accompanying drawings, which are not drawn to scale, and the illustrated components are not necessarily drawn proportionately to one another. It will be understood that these examples are intended to describe illustrative embodiments of the invention and are not intended to limit the scope of the invention in any way.

### EXAMPLES

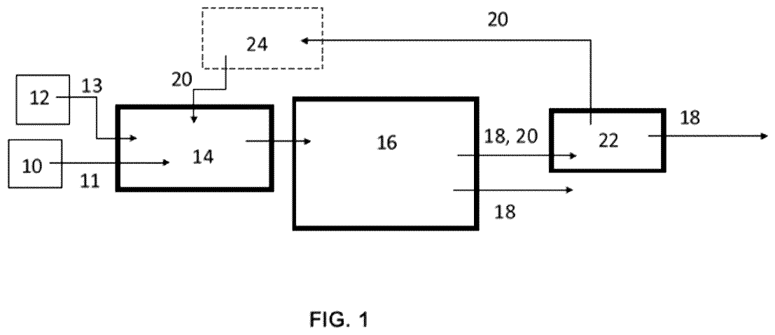

FIG. 1 depicts a flow diagram relating to an exemplary hydrogen storage and release system of the present disclosure.

The system comprises an H-reactor (16) in fluidic communication with a hydrogen gas source (10) and a source (12) of a hydrogen lean carrier fluid (lean-HCF) (13), for generating rich-HCF (18) via electrochemical exothermic reaction of hydrogen gas (11) and lean-HCF (13). The rich-HCF is transferred to a site of use.

Optionally, the hydrogen gas and lean-HCF are pre-mixed with water (20) optionally comprising inorganic salts, in a mixer (14) prior to introduction to the H-Reactor (16). In this embodiment, a liquid-liquid separator (22) is used to recover water and release a water-free rich-HCF (18). The recovered water is recycled to a storage chamber (24) for reuse.

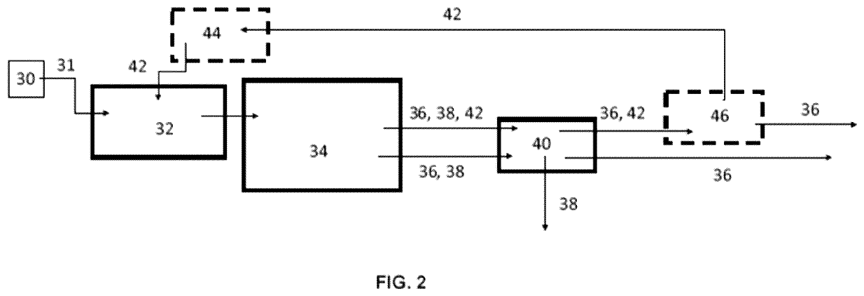

FIG. 2 depicts a flow diagram relating to another exemplary hydrogen storage and release system of the present disclosure.

The system comprises D-reactor (34) in fluidic communication with a source (30) of rich hydrogen carrier fluid (rich-HCF) (31). Lean-HCF (36) and hydrogen gas (38) are generated via the endothermic oxidation of rich-HCF (31) in the D-Reactor (34). These products are separated in a gas-liquid separation unit (40), and hydrogen gas (38) is released to the end-use application.

Optionally, the rich-HCF (31) is pre-mixed with water (42) optionally comprising inorganic salts, in a mixer (32) prior to introduction to the D-Reactor (34). Is this embodiment, gas-liquid separation unit (40) separates the hydrogen gas (38) from the liquid phase comprising lean-HCF and water. A liquid-liquid phase separator (46) is used to separate water (42) from the lean HCF (36), which is transported or stored for later hydrogenation. The recovered water (42) is recycled to a storage chamber (44) for reuse.

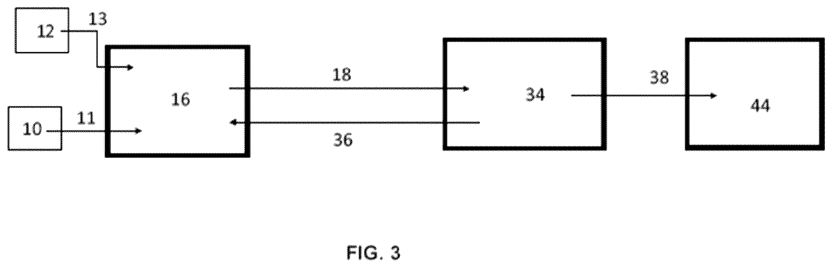

FIG. 3 depicts a flow diagram relating to relating to another exemplary hydrogen storage and release system of the present disclosure.

The system comprises H-reactor (16) in fluidic communication with a hydrogen gas source (10) and a source (12) of a hydrogen lean carrier fluid (lean-HCF) (13), and a D-reactor (34). The system of this example receives hydrogen gas (11) and a lean-HCF (13) into the H-reactor (12) to produce a rich-HCF (18), which is transferred to the D-reactor (34). The rich-HCF (18) is treated in D-reactor (34) to produce lean-HCF (36), and hydrogen gas and/or hydrogen fuel (38). The hydrogen gas (38) is transferred for end use application (44), and the lean-HCF (36) is re-cycled back to the H-reactor (16).

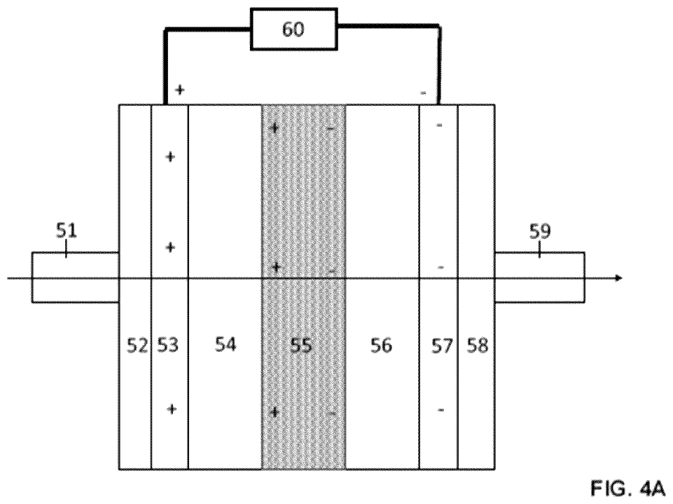

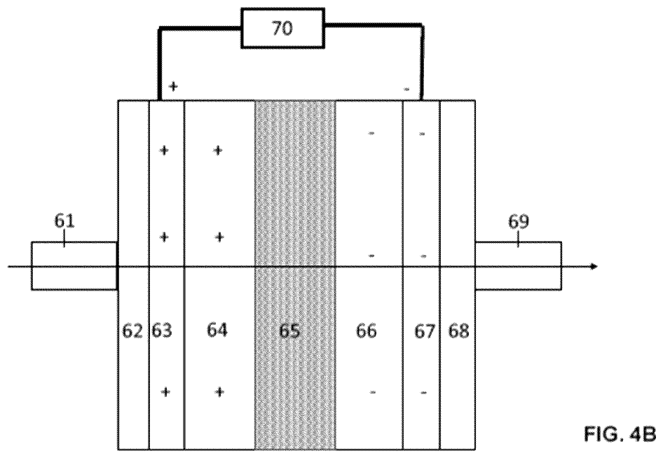

FIG. 4A Depicts a schematic representation of a perpendicular flow electrochemical reactor, comprising a three dimensional porous bipolar electrode, wherein:
51—Inlet port for hydrogen and lean-HCF (in H-reactor) or rich-HCF (in D-reactor), optionally mixed with water
52—End Plate
53—Anodic Current Collector
54—Non-Conductive Flow Distributor
55—Conductive Electrode (Bipolar)
56—Non-Conductive Flow Distributor
57—Cathodic Current Collector
58—End Plate
59—outlet for Rich-HCF (in H-reactor) or for hydrogen and lean-HCF (in D-reactor)
60—External Power Supply

FIG. 4B Depicts a schematic representation of a perpendicular flow electrochemical reactor, comprising a monopolar electrode(s), wherein:
61—Inlet port for hydrogen and lean-HCF (in H-reactor) or rich-HCF (in D-reactor), optionally mixed with water
62—End Plate
63—Anodic Current Collector
64—Conductive Diffusion Electrode (Monopolar Anode)
65—Non-Conductive Flow Distributor
66—Conductive Diffusion Electrode (Monopolar Cathode)
67—Cathodic Current Collector
68—End Plate
69—Outlet for Rich-HCF (in H-reactor) or for hydrogen and lean-HCF (in D-reactor)
70—External Power Supply

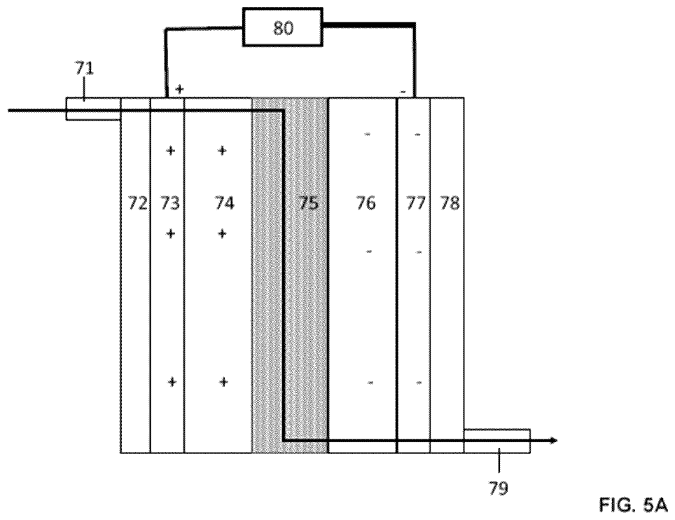

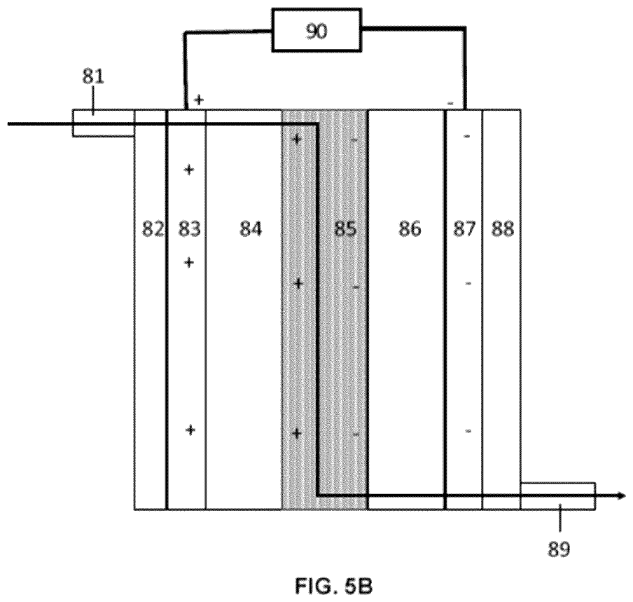

FIG. 5A depicts a schematic representation of a parallel flow undivided electrochemical reactor comprising a monopolar electrodes, wherein:
71—Inlet Port 71 for hydrogen and lean-HCF (in H-reactor) or rich-HCF (in D-reactor), optionally mixed with water
72—End Plate
73—Anodic Current Collector
74—Monopolar anode
75—Non-conductive flow distributor
76—Monopolar cathode
77—Cathodic Current Collector
78—Endplate
79—Outlet port 78 for Rich-HCF (in H-reactor) or for hydrogen and lean-HCF (in D-reactor)
80—External Power Supply

FIG. 5B depicts a schematic representation of a parallel flow undivided electrochemical reactor comprising a bipolar electrode, wherein:
81—Inlet port for hydrogen and lean-HCF (in H-reactor) or rich-HCF (in D-reactor), optionally mixed with water
82—End plate
83—Anodic Current Collector
84—Non-conductive flow distributor
85—Bipolar electrode
86—Non-conductive flow distributor
87—Cathodic Current Collector
88—Endplate
89—Outlet port 88 for Rich-HCF (in H-reactor) or for hydrogen and lean-HCF (in D-reactor)
90—External Power Supply

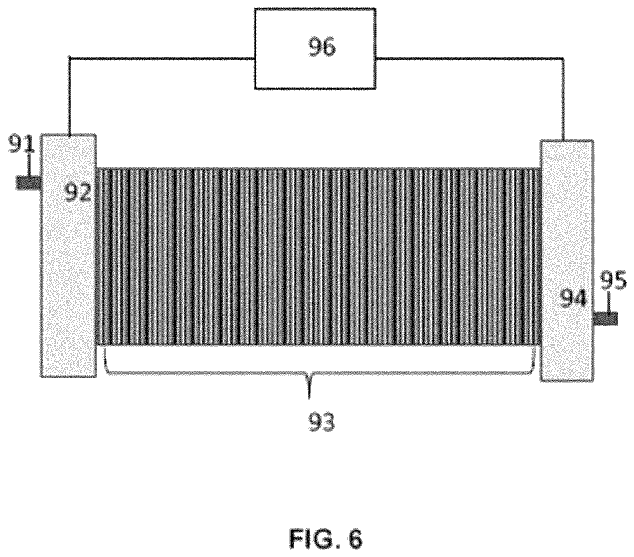

FIG. 6 is a schematic illustration of a parallel plate geometry of electrochemical reactors of the present disclosure, wherein:
91—Inlet for hydrogen and lean-HCF (in H-reactor) or rich-HCF (in D-reactor), optionally mixed with water
92—Anodic electrode
93—Bipolar or monopolar electrode assemblies (flow distributor/electrode combinations) having parallel or perpendicular flow
94—Cathodic electrode
95.—Outlet for Rich-HCF (in H-reactor) or for hydrogen and lean-HCF (in D-reactor)
96—External power supply.
The external power supply may or may not be connected to individual cells or groups of cells.

In one example, toluene is used as the LOHC in lean-hydrogen carrier fluid. The cell potential for hydrogenation of toluene (6H++6e−+toluene->methylcyclohexane) is 0.15 V, resulting in a Gibbs free energy of reaction of 43 KJ/kgH2.

1. A system for managing hydrogen storage and release, the system comprising:
an undivided electrochemical hydrogenation reactor (H-reactor) configured to receive a hydrogen lean carrier fluid (lean-HCF) and hydrogen gas,
the H-reactor comprising an anode for electrochemically oxidizing the hydrogen to generate protons and electrons, and a cathode for hydrogenating the lean-HCF with the generated protons and electrons to form a hydrogen rich carrier fluid (rich-HCF); and
a transfer system for transferring the rich-HCF from the H-reactor to a site of use.

2. The system of claim 1, wherein the site of use is an undivided electrochemical dehydrogenation reactor (D-reactor) configured to receive the transferred rich-HCF,
the D-reactor comprising an anode the D-reactor comprising for electrochemically dehydrogenating/oxidizing the rich-HCF to generate the lean-HCF and protons and electrons, and a cathode to generate a hydrogen gas from the generated protons and electrons.

3. The system of claim 2, further comprising a transfer system for recycling the lean-HCF from the D-reactor to the H-reactor.

4. A system for managing hydrogen production and storage, the system comprising: an undivided electrochemical dehydrogenation reactor (D-reactor) configured to receive a hydrogen rich carrier fluid (rich-HCF),
the reactor comprising an anode for electrochemically dehydrogenating/oxidizing the rich-HCF to produce a hydrogen lean carrier fluid (lean-HCF), protons and electrons, and an cathode to generate hydrogen gas from the generated protons and electrons; and
a transfer system for transferring the lean-HCF from the D-reactor to a site of use.

5. The system of claim 4, wherein the site of use is an undivided electrochemical hydrogenation reactor (H-reactor) configured to receive the transferred lean-HCF and hydrogen from a hydrogen source,
the H-reactor comprising an anode for electrochemically oxidizing the hydrogen to generate protons and electrons, and a cathode for hydrogenating the lean-HCF with the generated protons and electrons to form a hydrogen rich carrier fluid (rich-HCF).

6. The system of claim 5, further comprising a transfer system for recycling the rich-HCF from the H-reactor to the D-reactor.

7. The system of claim 1, wherein the cathodes and anodes of each of the undivided electrochemical reactors are independently selected from bipolar and monopolar electrodes.

8. The system of claim 7, wherein the electrodes are independently made of a catalytic material or a base material coated with a catalytic material.

9. The system of claim 8, wherein the catalytic material is independently a transition metal and/or a transition metal oxide.

10. The system of claim 1, wherein the H-reactor and/or the D-reactor further comprises an aqueous medium.

11. The system of claim 10, wherein the aqueous is water optionally comprising salts, acids, bases and/or emulsifiers.

12. The system of claim 10, wherein the lean-HCF and/or the rich-HCF forms an emulsion with the aqueous medium.

13. The system of claim 1, wherein the transfer system comprises one or more of storage containers and pipelines.
